(19) United States
(12) Patent Application Publication
(10) Pub. No.: US 2015/0252676 A1
(43) Pub. Date: Sep. 10, 2015

(54) SELECTION OF A PARTICULAR MATERIAL FOR STEAM TURBINE BLADES

(71) Applicant: NUOVO PIGNONE SRL, Florence (IT)

(72) Inventors: Michelangelo Bellacci, Florence (IT); Federico Iozzelli, Florence (IT); Massimiliano Buccioni, Florence (IT); Marco Manetti, Florence (IT)

(73) Assignee: Nuovo Pignone Srl, Florence (IT)

(21) Appl. No.: 14/430,673

(22) PCT Filed: Sep. 23, 2013
(86) PCT No.: PCT/EP13/69677

§ 371 Date: Mar. 24, 2015

(30) Foreign Application Priority Data
Sep. 24, 2012 (IT) CO2012A000047

(51) Int. Cl. F01D 5/28; F01D 1/02

(52) U.S. Cl. CPC F01D 5/28; F01D 1/02; F05D 2220/31; F05D 2300/10

(57) ABSTRACT

Apparatus and method for decreasing the corrosion susceptibility and/or the liquid droplet erosion susceptibility of one or more turbine blades associated with a steam turbine. One or more of the turbine blades are constructed of an Austenitic Nitrogen strengthened stainless steel; such Austenitic stainless steel has a weight percentage of manganese bigger than ten and preferably a weight percentage of nickel smaller than five; advantageously, such Austenitic stainless steel is strengthened with nitrogen. The blades constructed of such Austenitic stainless steel are configured in the later stages of the steam turbine.

### BACKGROUND

Embodiments of the subject matter disclosed herein generally relate to methods and devices and, more particularly, to mechanisms and techniques for using an austenitic stainless steel for steam turbine blades.

Steam turbines are utilized extensively in many industries today across a wide variety of applications. A significant problem associated with steam turbines is a failure of the turbine blades during operation. Turbine blades for a current art steam turbine are manufactured from Martensitic stainless steels but have drawbacks such as lower corrosion resistance and lower erosion resistance. Further, wear, erosion, general corrosion, also Stress Corrosion Cracking (SCC) and/or failure of a turbine blade on a steam turbine leads to costly downtime for repair or maintenance.

Specifically, the Martensitic steel turbine blades are corroded by compounds and contaminants associated with the high pressure steam. These compounds include but are not limited to chlorides, sulfides, bromides and carbon dioxides. Further, the Martensitic steel is susceptible to liquid droplet erosion based on the characteristics of the steam condensate at certain turbine blade locations due to the high angular velocity of the turbine blades. Market pressure is building for a material that is more tolerant of the operating conditions of the turbine blades in a steam turbine.

Accordingly, it would be desirable to provide designs and methods that avoid the afore-described problems and drawbacks.

### SUMMARY

According to one exemplary embodiment, there is a steam turbine blade apparatus. The exemplary embodiment continues with a hub for connecting to a shaft. Next in the exemplary embodiment, a plurality of turbine blades are connected to the hub and configured to expand high pressure steam wherein one or more of the plurality of turbine blades is constructed of Austenitic stainless steel having a weight percentage of manganese greater than ten.

According to another exemplary embodiment, there is a steam turbine apparatus. The exemplary embodiment comprises a casing for enclosing the steam turbine components. Next in the exemplary embodiment, a plurality of turbine blades mounted on a rotating shaft associated with the casing, wherein the turbine blades are configured to expand high pressure steam and one or more of the turbine blades are constructed of Austenitic stainless steel. Continuing with the exemplary embodiment, an inlet connection allowing entry of high pressure steam adjacent to the plurality of turbine blades. Further in the exemplary embodiment, an outlet connection allowing exit of the expanded high pressure steam adjacent to the plurality of turbine blades. According to this exemplary embodiment, at least turbine blades in a stage which is far from the inlet connection and close to the outlet connection are constructed of Austenitic stainless steel.

According to another exemplary embodiment, there is a method for decreasing the corrosion susceptibility and/or the liquid droplet susceptibility of one or more turbine blades in a steam turbine. Continuing with the exemplary embodiment, the method constructs one or more of the turbine blades of an Austenitic stainless steel having a weight percentage of manganese greater than ten. Next in the exemplary embodiment, any remaining turbine blades are constructed of a Martensitic stainless steel. Continuing with the exemplary embodiment, the method attaches the one or more turbine blades of Austenitic stainless steel and the remaining turbine blades of Martensitic stainless steel to a hub associated with the steam turbine such that the one or more Austenitic stainless steel turbine blades are later stage turbine blades.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is an exemplary embodiment depicting a steam turbine and a series of turbine blades;

FIG. 2 is an exemplary embodiment depicting a plurality of steam turbine blades; and

FIG. 3 is an exemplary method embodiment flowchart depicting a method for improving the reliability and performance of a turbine blade based on reducing corrosion susceptibility and liquid droplet erosion.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of steam turbines.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

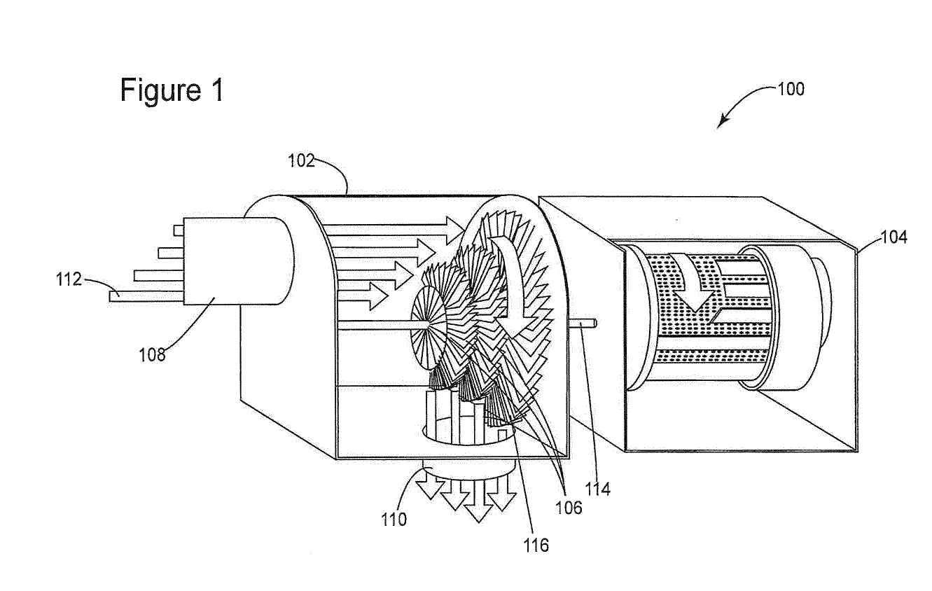

Turning now to FIG. 1, an exemplary embodiment depicts a steam turbine generator 100 comprising a steam turbine 102, and a generator 104. Note, however, that this is merely an exemplary application of a steam turbine for illustration purposes and that steam turbines in accordance with the present invention may alternatively be connected to other devices, e.g., compressors. The steam turbine 102 further comprises a plurality of turbine blades 106, a steam entry location 108, a steam exit location 110 and high pressure steam 112. The turbine blades of the steam turbine are attached to a shaft 114 that is connected to the generator 104.

Continuing with the exemplary embodiment, the high pressure steam 112 enters the steam turbine 102 and expands through the steam turbine blades 106. Based on the reduction in pressure as the steam expands and performs work on the turbine blades 106, the water chemistry characteristics change, forming liquid droplets that would erode the later stage turbine blades 116 of the steam turbine 102 if not for the type of steel used to construct the later stage turbine blades 116. Continuing with the exemplary embodiment, the later stage turbine blades 116 are constructed of Austenitic, high manganese and high nitrogen content stainless steel; more particularly, the weight percentage of manganese in the steel is more than ten and the weight percentage of nickel in the steel is more than one half. One example of an Austenitic, nitrogen strengthened steel which can be used to make later stage turbine blades 116 is 15-15HS steel described in U.S. Pat. No. 5,094,812, the disclosure of which is important for the present disclosure and is incorporated herein by reference. It should be noted in the exemplary embodiment that stress corrosion cracking (SCC) resistance has been tested using 15-15HS and evidences no susceptibility to SCC due to chlorides according to the ASTM G123 test method while the Martensitic stainless steel M152, that is commonly used for constructing components of steam turbine stages, exhibits SCC susceptibility under the same test and conditions.

According the exemplary embodiment, the high-percentage manganese increases workability and allows an elevate strengthening by warm-working, so such Austenitic stainless steel performs on par with Martensitic stainless steel with respect to mechanical strength. Through the high addition of nitrogen into the steel composition, both mechanical properties and corrosion resistance grow significantly. Further, according to the exemplary embodiment, such Austenitic stainless steel is less susceptible to general corrosion as well as SCC, and, furthermore, due to the high toughness and high hardness, it exhibits optimal liquid droplet erosion resistance; if such Austenitic stainless steel is used for constructing late stage turbine blades, better performance may be achieved and lesser maintenance is required.

It should be noted that one or more of the turbine blades associated with a steam turbine can be constructed of an Austenitic stainless steel having a high-manganese and/or high-nitrogen and/or low nickel content. However, according to some exemplary embodiments, only the turbine blades of the last low pressure stages (i.e., the stage which is furthest from the steam inlet 108) are made from such Austenitic stainless steel where the temperature is lower and the steam is prevalent in water phase.

Alternatively, according to other embodiments, the last few stages, e.g., two or three stages, furthest away from the steam inlet can have blades which are formed from Austenitic stainless steel having a high-manganese and/or high-nitrogen and/or low nickel content, e.g., 15-15HS steel, while the remaining stages can have turbine blades which are made from Martensitic stainless steel. It should be noted that, according to exemplary embodiments, Austenitic stainless steels suitable for use as late stage turbine blades are Austenitic stainless steels comprising nickel of less than five weight percent, manganese of greater than ten weight percent and nitrogen greater than one half weight percent.

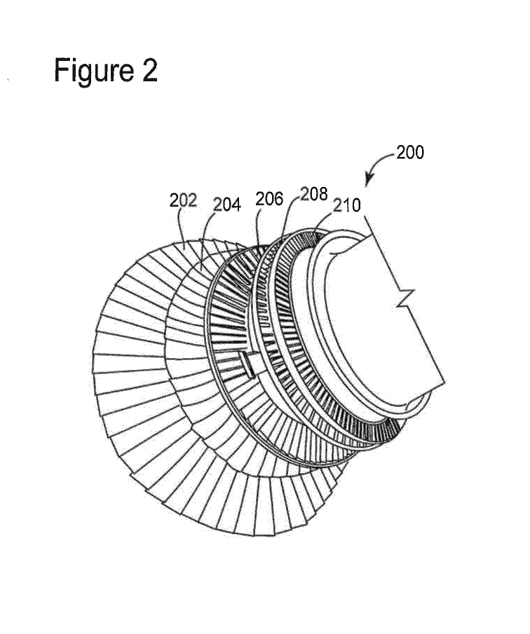

Looking now to FIG. 2, an exemplary embodiment of a plurality of turbine blades 200 is depicted. In the exemplary embodiment, the late stage turbine blades 202, 204 are characteristic of turbine blades suitable for manufacture from an Austenitic stainless steel, more particularly an Austenitic stainless steel having a high-manganese and/or high-nitrogen and/or low nickel content. It should be noted in the exemplary embodiment that all of the turbine blades 202, 204, 206, 208, 210 can be manufactured from Austenitic stainless steel if desired; it may be possible to use different Austenitic stainless steels for distinct stages.

As mentioned above, Austenitic stainless steel suitable for use in the manufacture of steam turbine blades according to exemplary embodiments can, for example, be one of the steel alloys described in the above-mentioned U.S. Pat. No. 5,094,812. It should be noted in such embodiments that the addition of nitrogen strengthens the Austenitic stainless steel such that the mechanical properties allow for the use of the steel in an application such as a steam turbine blade. Further in the exemplary embodiment, the lower concentration of carbon in the Austenitic stainless steel improves the turbine blade's ability to resist intergranular stress corrosion cracking. It should also be noted in the exemplary embodiment that Austenitic stainless steel has stress corrosion cracking resistance better than typical Martensitic stainless steel, has general corrosion resistance better than typical Martensitic stainless steel and has liquid droplet erosion resistance and mechanical properties at least as good or better than typical Martensitic stainless steel.

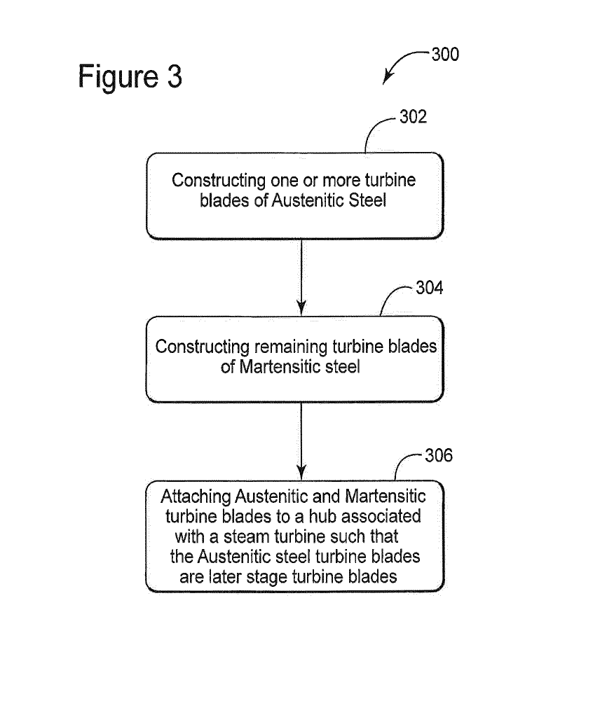

Looking now to FIG. 3, a flowchart 300 of an exemplary method embodiment for decreasing the corrosion susceptibility and the liquid droplet erosion susceptibility of one or more turbine blades in a steam turbine is depicted. First at step 302 of the exemplary embodiment, one or more turbine blades associated with a steam turbine are constructed using an Austenitic stainless steel, in particular an Austenitic stainless steel having a high-manganese and/or high-nitrogen and/or low nickel content. It should be noted in the exemplary method embodiment that the Austenitic stainless steel is strengthened with Nitrogen.

Next at step 304 of the exemplary method embodiment, any remaining turbine blades associated with the steam turbine are constructed of a Martensitic stainless steel. Next at step 306 of the exemplary method embodiment, the turbine blades, both Austenitic and Martensitic, are attached to a hub or hubs (e.g. a plurality hub portions that are connected to each other to form a single hub) associated with a steam turbine such that the Austenitic blades are configured as later stage turbine blades. It should be noted in the exemplary embodiment that the hub is constructed of Martensitic stainless steel.

The disclosed exemplary embodiments provide a system and a method for improving the performance and durability of a steam turbine. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements to those recited in the literal languages of the claims.

What is claimed is:

1. A steam turbine blade apparatus, comprising:
a hub for connecting to a shaft; and
a plurality of turbine blades connected to the hub and configured to expand high pressure steam, wherein one or more of the plurality of turbine blades are constructed of Austenitic stainless steel,
wherein weight percentage of manganese in the Austenitic stainless steel is greater than ten.

2. The apparatus of claim 1, wherein weight percentage of nickel in the Austenitic stainless steel is less than five.

3. The apparatus of claim 1, wherein the Austenitic stainless steel is strengthened with nitrogen.

4. The apparatus of claim 1, wherein weight percentage of nitrogen in the Austenitic stainless steel is greater than one half.

5. The apparatus of claim 1, wherein the hub is constructed of Martensitic stainless steel.

6. A steam turbine apparatus, the apparatus comprising:
a casing for enclosing steam turbine components;
a plurality of turbine blades mounted in a plurality of stages on a rotating shaft associated with the casing wherein the turbine blades are configured to expand high pressure steam and one or more of the turbine blades are constructed of an Austenitic stainless steel;
an inlet connection allowing entry of high pressure steam adjacent to the plurality of turbine blades; and
an outlet connection allowing exit of expanded high pressure steam adjacent to the plurality of turbine blades,
wherein at least some of the turbine blades in a stage which is far from the inlet connection and close to the outlet connection are constructed of Austenitic stainless steel.

7. The apparatus of claim 6, wherein only turbine blades in one stage which is furthest from the inlet connection are constructed of Austenitic stainless steel.

8. The apparatus of claim 7, wherein the one stage which is furthest from the inlet connection comprises a hub constructed of Martensitic stainless steel.

9. The apparatus of claim 6, wherein only turbine blades in a plurality of consecutive stages which are closest to the outlet connection are constructed of Austenitic stainless steel.

10. The apparatus of claim 9, wherein each stage of the plurality of consecutive stages comprises a hub constructed of Martensitic stainless steel.

11. The apparatus of claim 6, further comprising one or more stages entirely constructed of Martensitic stainless steel.

12. The apparatus of claim 11, wherein at least the stage closest to the inlet connection is entirely constructed of Martensitic stainless steel.

13. The apparatus of claim 6, wherein Austenitic stainless steel turbine blades of any stage are constructed of a same Austenitic stainless steel, and wherein Austenitic stainless steel turbine blades of distinct stages are constructed of different Austenitic stainless steels.

14. A steam turbine apparatus, the apparatus comprising:
a casing for enclosing the steam turbine components;
a plurality of turbine blades mounted in a plurality of stages on a rotating shaft associated with the casing wherein the turbine blades are configured to expand high pressure steam and one or more of the turbine blades are constructed of an Austenitic stainless steel;
an inlet connection allowing entry of high pressure steam adjacent to the plurality of turbine blades; and
an outlet connection allowing exit of expanded high pressure steam adjacent to the plurality of turbine blades,
wherein at least some of the turbine blades in a stage are the steam turbine blade apparatus of claim 1.

15. A method for decreasing the corrosion susceptibility and/or the liquid droplet erosion susceptibility of one or more turbine blades in a steam turbine, the method comprising:
constructing the one or more turbine blades with an Austenitic stainless steel having a weight percentage of manganese greater than ten;
constructing any remaining turbine blades associated with the steam turbine with Martensitic stainless steel; and
attaching the one or more turbine blades of Austenitic stainless steel and the remaining turbine blades of Martensitic stainless steel to a hub associated with the steam turbine such that the one or more turbine blades of Austenitic stainless steel are later stage turbine blades.

16. The method of claim 15, wherein weight percentage of nickel in the Austenitic stainless steel is less than five.
